(19) United States
(12) Patent Application Publication
(10) Pub. No.: US 2011/0228143 A1
(43) Pub. Date: Sep. 22, 2011

(54) IMAGING DEVICE AND COMPUTER-READABLE MEDIUM

(75) Inventor: Kazuhiro MAKINO, Kanagawa (JP)

(73) Assignee: FUJIFILM CORPORATION, Tokyo (JP)

(21) Appl. No.: 13/013,202

(22) Filed: Jan. 25, 2011

(30) Foreign Application Priority Data
Mar. 19, 2010 (JP) 2010-064986

(51) Int. Cl. H04N 9/64; H04N 5/335

(52) U.S. Cl. 348/243; 348/294; 348/E09.037; 348/E05.091

(57) ABSTRACT

In an imaging device, a cooling unit cools an imaging element. A storage unit stores table data representing correspondence relationships between signal values based on luminescences of detection targets, cooling temperatures, exposure times, and S/N ratios. A S/N calculating unit calculates a S/N ratio at a time when pre-imaging has been performed. A determination unit determines, from the table data and as a cooling temperature and an exposure time for the imaging, a combination of a cooling temperature and an exposure time with which the S/N ratio becomes equal to or greater than the reference S/N ratio on the basis of a result of comparison between the calculated S/N ratio and a predetermined reference S/N ratio. A control unit controls the imaging element and the cooling element such that a subject is imaged at the cooling temperature and in the exposure time that are determined.

### CROSS-REFERENCE TO RELATED APPLICATION

This application claims priority under 35 USC 119 from Japanese Patent Application No. 2010-064986 filed on Mar. 19, 2010, the disclosure of which is incorporated by reference herein.

### BACKGROUND OF THE INVENTION

1. Field of the Invention

The present invention pertains to an imaging device and a computer-readable medium storing an imaging program and particularly relates to an imaging device equipped with a cooling unit that cools an imaging element and a computer-readable medium storing an imaging program.

2. Description of the Related Art

Conventionally, in the field of biochemistry, for example, there has been proposed an imaging device that images, as a subject, a fluorescent sample labeled by a fluorescent dye that emits fluorescent light when it is irradiated with excitation light or images, as a subject, a chemiluminescent sample that emits light when it contacts a chemiluminescent substrate (e.g., see Japanese Patent Application Laid-Open (JP-A) No. 2005-283322).

In this imaging device, particularly in a case where the imaging device images a chemiluminescent sample, the imaging device images a subject that emits faint light without being irradiated with excitation light, so the exposure time becomes long as compared to a case where the imaging device images a fluorescent sample. When the exposure time becomes long, many noise components resulting from influences such as dark current corresponding to the temperature and the exposure time end up becoming included in the image captured by the imaging element such as a CCD. In order to prevent this, the imaging device described in JP-A No. 2005-283322 is disposed with a unit that cools the CCD.

As an imaging device that cools the CCD in this manner, JP-A No. 2005-354258 discloses an imaging device that predicts, on the basis of the temperature inside the imaging device and the like, random noise that is readout noise in a charge-to-voltage conversion circuit inside the imaging element and fixed pattern noise resulting from the dark current component and determines an exposure time and a target temperature inside the imaging element such that the larger of the noises decreases.

JP-A No. 2008-177917 discloses an imaging device that raises the drive voltage of a cooling element as the exposure time becomes longer.

### SUMMARY OF THE INVENTION

The present invention has been made in view of the above circumstances and provides an imaging device and a computer-readable medium storing an imaging program

According to an aspect of the invention, there is provided an imaging device which includes: an imaging element that images a subject including predetermined detection targets; a cooling unit that cools the imaging element; a storage unit that stores table data representing correspondence relationships between signal values based on light quantities of the detection targets, cooling temperatures of the cooling unit, exposure times when imaging the subject, and S/N ratios that are ratios between the signal values based on the light quantities of the detection targets and a signal value of a light quantity of a background portion of the detection targets; a S/N ratio calculating unit that calculates a S/N ratio when the subject has been pre-imaged by the imaging element at a predetermined reference cooling temperature and in a predetermined reference exposure time; a determination unit which, on the basis of the result of a comparison between the S/N ratio calculated by the S/N ratio calculating unit and a predetermined reference S/N ratio, determines, from the table data and as a cooling temperature and an exposure time for the imaging, a combination of a cooling temperature and an exposure time with which the S/N ratio becomes equal to or greater the reference S/N ratio from among combinations of the cooling temperatures and the exposure times based on the light quantities of the detection targets when the pre-imaging was performed; and a control unit that controls the imaging element and the cooling unit such that the subject is imaged at the cooling temperature and in the exposure time that are determined by the determination unit.

### BRIEF DESCRIPTION OF THE DRAWINGS

A preferred embodiment of the present invention will be described in detail based on the following figures, wherein:

FIG. 1 is a perspective view of an imaging system;

FIG. 2 is a front view of an imaging device;

FIG. 3 is a general block diagram of an image processing device 100;

FIG. 4 is a general block diagram of an imaging unit 30;

FIG. 5 is a graph showing one example of a readout noise characteristic;

FIG. 6 is a graph showing one example of a dark current noise characteristic;

FIG. 7 is a diagram giving table data showing relationships between cooling temperatures, exposure times, luminescences of subjects, and S/N ratios;

FIG. 8 is a flowchart of a control routine executed in the image processing device;

FIG. 9 is a diagram showing one example of captured images of chemiluminescent samples; and

FIG. 10 is a graph showing a histogram of a captured image.

### DETAILED DESCRIPTION OF THE INVENTION

Conventionally, imaging devices have determined reading conditions such as appropriate cooling temperatures and exposure times by trial and error, which takes time. Further, there are cases where, even when the subject is one where it suffices for the exposure time to be short, the imaging device ends up needlessly consuming electrical power, such as a case where the imaging device ends up excessively cooling the imaging element.

The present invention provides an imaging device that can determine an optimum cooling temperature and exposure time depending on the luminescence of the subject and suppress needless electrical power consumption at the time of imaging. The present invention also provides a computer-readable medium storing an imaging program.

An embodiment of the present invention will be described below with reference to the drawings.

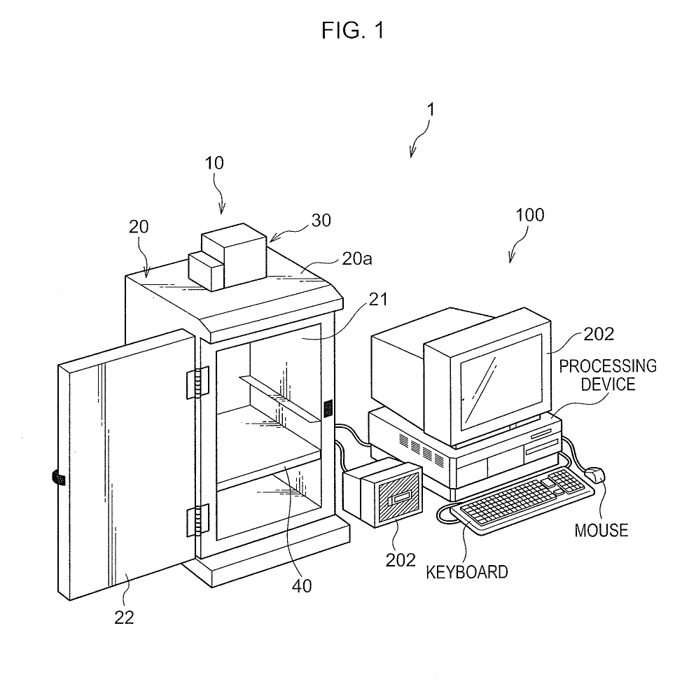

FIG. 1 is a perspective view showing one example of an imaging system 1 using an imaging device pertaining to the present invention. The imaging system 1 is an imaging system that, depending on the subject, irradiates or does not irradiate the subject with excitation light and images the subject to acquire a captured image of the subject. The imaging system 1 is configured to include an imaging device 10 and an image processing device 100.

The imaging device 10 outputs image data of the subject it has acquired by imaging the subject to the image processing device 100. The image processing device 100 administers predetermined image processing as needed with respect to the image data it has received and causes a display unit 202 to display an image of the subject.

The subject may be the aforementioned chemiluminescent sample or a fluorescent sample, for example. In the present embodiment, a case where the subject is a chemiluminescent sample and the imaging device 10 images the subject without irradiating the subject with excitation light will be described.

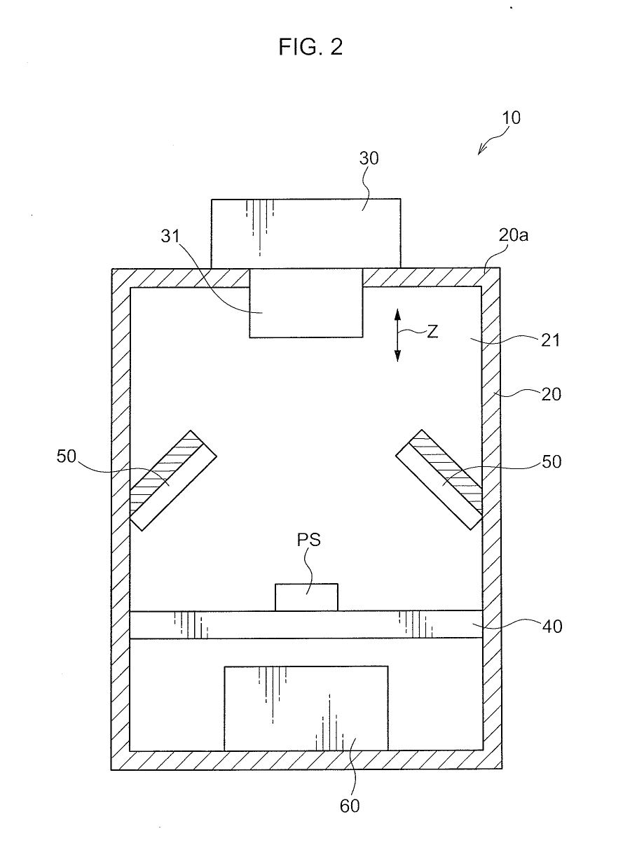

FIG. 2 shows a front view of the imaging device 10 in a state where a cover 22 (see FIG. 1) has been opened. As shown in FIG. 2, the imaging device 10 is equipped with a subject placement portion 40 on which a subject PS is placed, a casing 20 that houses the subject placement portion 40 inside, an imaging unit 30 that images the subject PS placed on the subject placement portion 40, epi-illuminators 50 placed inside the casing 20 that irradiate the subject PS with excitation light, and a transilluminator 60.

The casing 20 has a hollow portion 21 formed in a substantially cuboid and has the subject placement portion 40 on which the subject PS is placed. The cover 22 shown in FIG. 1 is attached to the casing 20 such that the cover 22 can be opened and closed, and the user can open the cover 22 and house the subject PS inside the casing 20. In this manner, the casing 20 configures a dark box where outside light does not enter inside the hollow portion 21.

The imaging device 10 is configured to include an imaging element such as a CCD, for example, that is fixed to a top surface 20a of the casing 20 and whose details will be described later. A cooling element is attached to the imaging element and cools the imaging element, to thereby prevent noise components resulting from dark current from being included in image information that has been captured.

A lens unit 31 is installed in the imaging device 10. This lens unit 31 is disposed so as to be movable in the direction of arrow Z to focus on the subject PS.

The epi-illuminators 50 emit excitation light towards the subject PS placed on the subject placement portion 40. The transilluminator 60 irradiates the subject PS with excitation light from under the subject PS. In a case where the imaging device 10 images a fluorescent sample, the imaging device 10 irradiates the subject with excitation light from at least one of the epi-illuminators 50 and the transilluminator 60 depending on the subject.

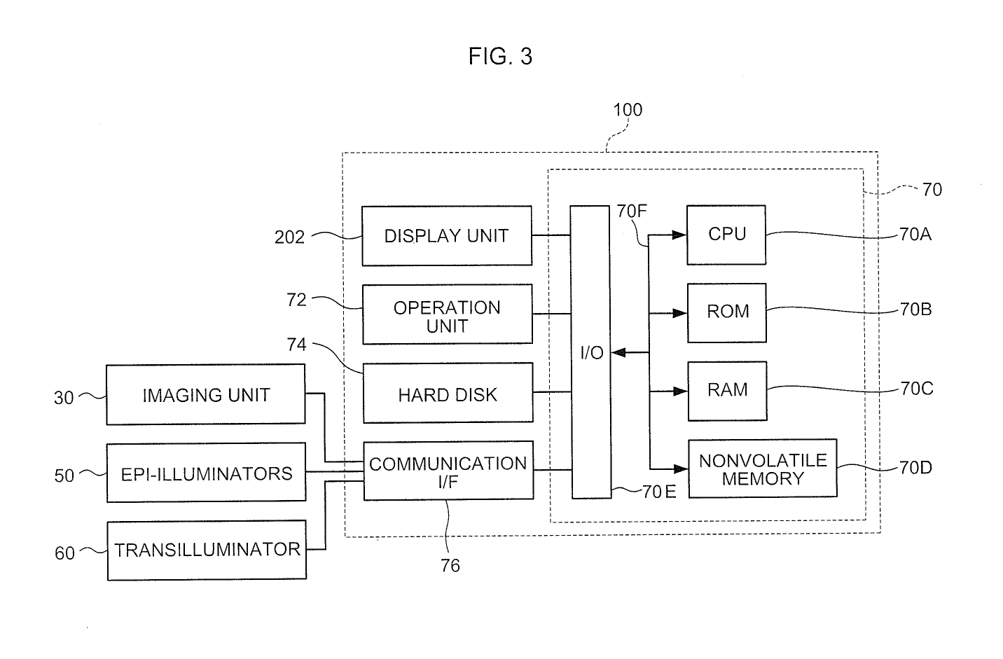

FIG. 3 shows the general configuration of the image processing device 100. As shown in FIG. 3, the image processing device 100 is configured to include a main controller 70.

The main controller 70 has a configuration where a central processing unit (CPU) 70A, a read-only memory (ROM) 70B, a random access memory (RAM) 70C, a nonvolatile memory 70D, and an input/output interface (I/O) 70E are interconnected via a bus 70F.

The display unit 202, an operation unit 72, a hard disk 74, and a communication interface (I/F) 76 are connected to the I/O 70E. The main controller 70 centrally controls each of these functional parts.

The display unit 202 is configured by a CRT or a liquid crystal display device, for example, displays images that have been captured by the imaging device 10, and displays screens for performing various settings and giving instructions with respect to the imaging device 10.

The operation unit 72 is configured to include a mouse and a keyboard and is for allowing the user to give various instructions to the imaging device 10 by operating the operation unit 72.

The hard disk 74 stores image data of captured images captured by the imaging device 10, a control program of a later-described control routine, image processing programs, and various types of data such as table data.

The communication interface (I/F) 76 is connected to the imaging unit 30, the epi-illuminators 50, and the transilluminator 60 of the imaging device 10. The CPU 70A uses the communication unit I/F 76 to instruct the imaging unit 30 to perform imaging in imaging conditions corresponding to the type of subject or, in a case where the imaging device 10 is to irradiate the subject with excitation light, to instruct at least one of the epi-illuminators 50 and the transilluminator 60 to irradiate the subject with excitation light, receive the image data of the captured image captured by the imaging unit 30, and administer image processing and the like.

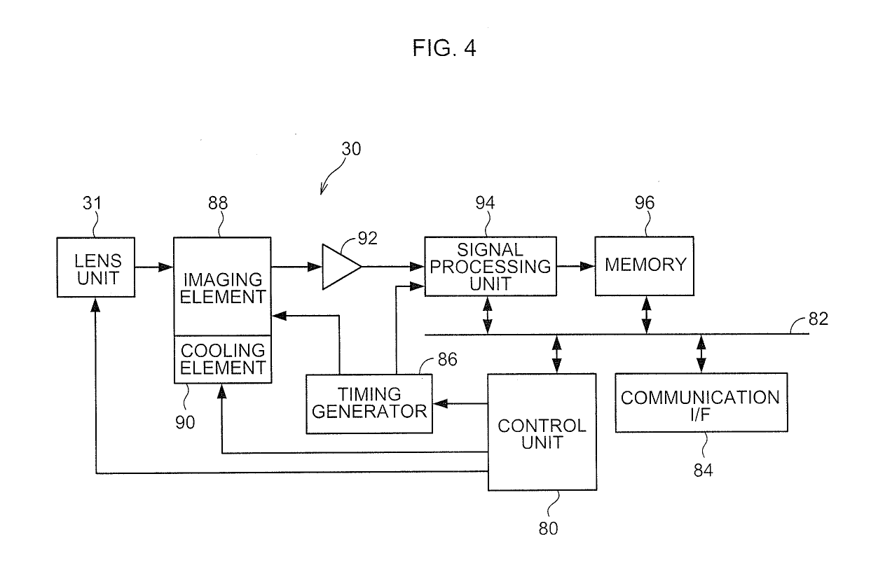

FIG. 4 shows the general configuration of the imaging unit 30. As shown in FIG. 4, the imaging unit 30 is equipped with a control unit 80. The control unit 80 is connected to a communication interface (I/F) 84 via a bus 82. The communication I/F 84 is connected to the communication I/F 76 of the image processing device 100.

When imaging is instructed from the image processing device 100 via the communication I/F 84, the control unit 80 controls each part according to the instruction content, images the subject PS placed on the subject placement portion 40, and transmits the image data of the captured image to the image processing device 100 via the communication I/F 84.

The lens unit 31, a timing generator 86, and a cooling element 90 that cools an imaging element 88 are connected to the control unit 80.

Although not shown, the lens unit 31 is configured to include, for example, a lens group comprising plural optical lenses, a diaphragm mechanism, a zoom mechanism, and an auto-focus mechanism. The lens group is disposed so as to be movable in the direction of arrow Z in FIG. 2 to focus on the subject PS. The diaphragm mechanism changes the diameter of an aperture to adjust the quantity of light made incident on the imaging element 88. The zoom mechanism adjusts the position where the lenses are placed to perform zooming. The auto-focus mechanism adjusts the focal point depending on the distance between the subject PS and the imaging device 10.

Light from the subject PS is transmitted through the lens unit 31 and is imaged on the imaging element 88 as a subject image.

Although not shown, the imaging element 88 is configured to include light receiving units corresponding to plural pixels, a horizontal transfer path, and a vertical transfer path. The imaging element 88 has the function of photoelectrically converting the subject image imaged on its imaging surface into electrical signals. For example, an image sensor such as a charge-coupled device (CCD) or a metal-oxide-semiconductor (MOS) is used for the imaging element 88.

The imaging element 88 is controlled by timing signals from the timing generator 86 and photoelectrically converts, in each light receiving unit, the incident light from the subject PS.

The signal charges that have been photoelectrically converted in the imaging element 88 become analog signals that have been converted into voltages by a charge-to-voltage conversion amp 92, and the analog signals are outputted to a signal processing unit 94.

The timing generator 86 has an oscillator that generates a basic clock (system clock) causing the imaging unit 30 to operate and, for example, supplies this basic clock to each part and also frequency-divides this basic clock to generate various timing signals. For example, the timing generator 86 generates timing signals representing vertical synchronizing signals, horizontal synchronizing signals, and electronic shutter pulses and supplies these to the imaging element 88. Further, the timing generator 86 generates timing signals such as sampling pulses for correlated double sampling and a conversion clock for analog-to-digital conversion and supplies these to the signal processing unit 94.

The signal processing unit 94 is controlled by timing signals from the timing generator 86 and is configured to include a correlated double sampling (CDS) circuit that administers correlated double sampling processing with respect to the analog signals inputted thereto and an analog-to-digital (A/D) converter that converts the analog signals to which correlated double sampling processing has been administered into digital signals.

The correlated double sampling processing is processing that obtains accurate pixel data by calculating, with the purpose of reducing noise and the like included in the output signals of the imaging element 88, the difference between the feedback component level and the image signal component level included in the output signals per light receiving element (pixel) of the imaging element 88.

The analog signals on which the correlated double sampling processing has been performed by the correlated double sampling circuit are converted into digital signals by the analog-to-digital converter, and the digital signals are outputted to a memory 96 where they are primarily stored. The image data that have been primarily stored in the memory 96 are transmitted to the image processing device 100 via the communication I/F 84.

The cooling element 90 is configured by a Peltier element, for example, and its cooling temperature is controlled by the control unit 80. In a case where the subject PS is a chemiluminescent sample, the imaging device 10 performs imaging by exposing the chemiluminescent sample for a relatively long amount of time without irradiating the chemiluminescent sample with excitation light, so there are cases where image quality is adversely affected as a result of, for example, the dark current noise of the imaging element 88 increasing depending on the temperature and the exposure time. For this reason, the control unit 80 controls the cooling element 90 so as to cool the imaging element 88 on the basis of the cooling temperature that has been instructed from the image processing device 100.

Examples of noise components adversely affecting the image quality of the captured image include readout noise, which arises when the charge-to-voltage conversion amp 92 converts the signal charges read out from the imaging element 88 into voltages, and dark current noise, which arises because of charges generated by heat even in a state where light is not made incident. Readout noise and dark current noise have somewhat different characteristics depending on the imaging element.

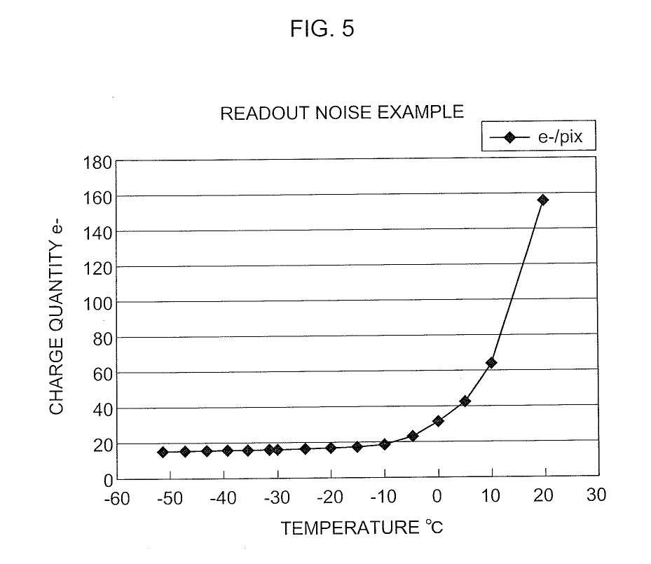

FIG. 5 shows one example of a readout noise characteristic. In FIG. 5, the horizontal axis represents the temperature of the imaging element 88 and the vertical axis represents the charge quantity of the readout noise per pixel. As shown in FIG. 5, the readout noise is temperature-dependent, so that as the temperature becomes lower, the noise becomes smaller. However, when the temperature is lowered up to a point, the noise does not become that much smaller even when the temperature is lowered beyond that.

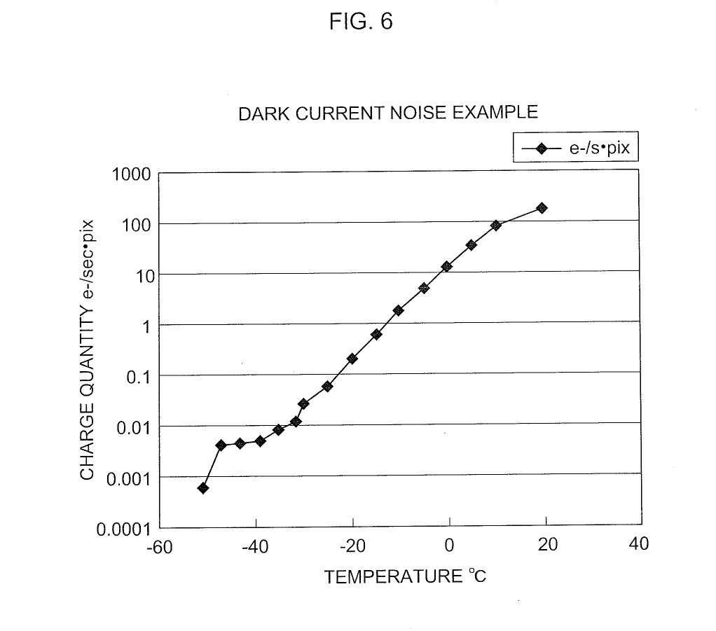

FIG. 6 shows an example of a dark current noise characteristic. In FIG. 6, the horizontal axis represents the temperature of the imaging element 88 and the vertical axis represents the charge quantity of the dark current noise per second and per pixel. As shown in FIG. 6, the dark current noise is also temperature-dependent, so that as the temperature becomes lower, the noise becomes smaller. Further, the dark current noise increases with time, that is, the longer the exposure time when imaging the subject becomes.

In a case where the subject is a chemiluminescent sample such as a protein, the luminescence of the chemiluminescent sample is faint, so it is necessary to establish the cooling temperature and the exposure time such that the S/N ratio, which is the ratio between the signal value (signal strength) based on the light quantity of the protein that is the detection target and the signal value based on the light quantity of the background portion, becomes equal to or greater than a reference S/N ratio (e.g., 3) predetermined as a S/N ratio reference at which the detection target can be excellently detected.

However, when the exposure time is lengthened and the cooling temperature is lowered more than necessary, electrical power is needlessly consumed.

Thus, in the present embodiment, correspondence relationships between cooling temperatures of the imaging element 88, exposure times, luminescences of detection targets, and S/N ratios are obtained beforehand by experiment or the like and stored as table data, and optimum cooling temperatures and exposure times are determined depending on the light amounts of the subjects on the basis of the table data.

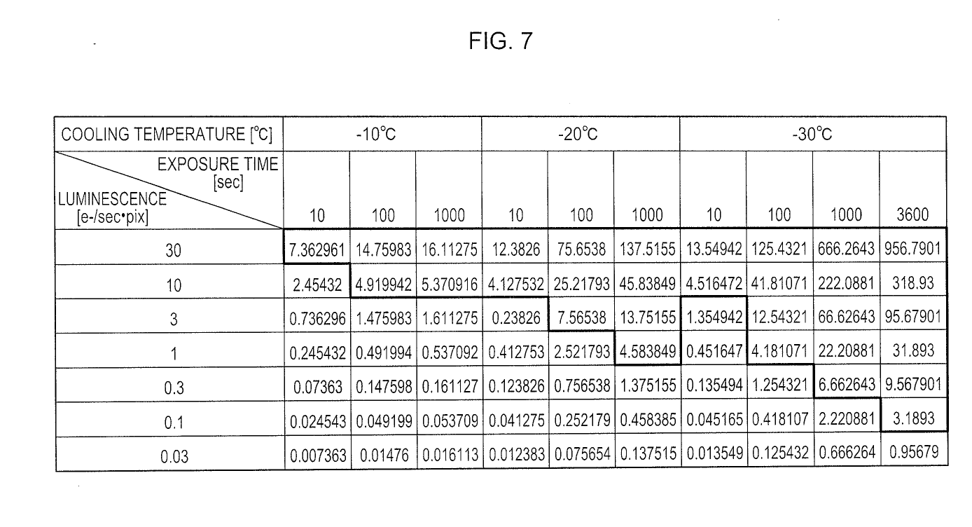

The numerical values shown in the boxes of the table data shown in FIG. 7 represent S/N ratios. These S/N ratios are generated from the result of having calculated S/N ratios in conditions in which combinations of cooling temperatures, exposure times, and signal values obtained by converting luminescences of detection targets into charge quantities per second and per pixel differ. The values in the boxes inside the bolded frame are S/N ratios equal to or greater than the reference S/N ratio (=3).

SN(T), which represents a S/N ratio in a case where the cooling temperature is T (° C.), is given by the following expression, with S(T) representing the signal value (signal strength) of the detection target and BG(T) representing the signal value of the background of the detection target.

SN(T)=(S(T)−BG(T))/BGσ(T) (1)

Here, BG(T) is given by the following expression, with NR(T) [e−] representing the readout noise in a case where the cooling temperature is T, ND(T) [e−/sec] representing the dark current noise, and Te [sec] representing the exposure time.

BG(T)=NR(T)+ND(T)×Te (2)

BGσ(T) is a standard deviation value of the signal value of the background of the detection target and is given by the following expression.

BGσ(T)={NR(T)²+(ND(T)×Te)²}^{1/2} (3)

The table data shown in FIG. 7 are obtained by changing the combinations of cooling temperatures, exposure times, and luminance amounts of detection targets and obtaining SN(T) on the basis of the above-described expressions (1) to (3). These table data are stored beforehand in the hard disk 74 of the image processing device 100, for example.

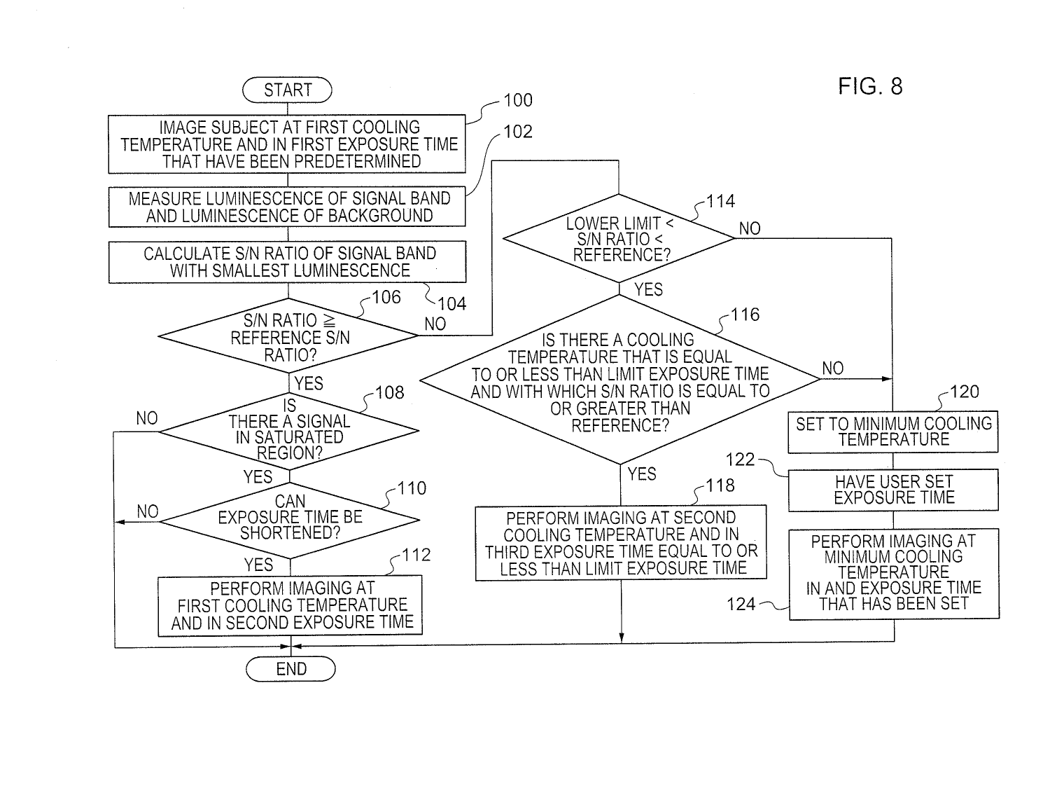

Next, processing executed by the CPU 70A of the image processing device 100 will be described, with reference to the flowchart shown in FIG. 8, as the action of the present embodiment.

In the present embodiment, a case where the imaging device 10 images a chemiluminescent sample without irradiating the chemiluminescent sample with excitation light will be described. In this case, the user places the chemiluminescent sample serving as the subject PS on the subject placement portion 40 and closes the cover 22. An imaging menu screen is displayed on the display unit 202 of the image processing device 100, and the user selects the imaging mode of the chemiluminescent sample and instructs imaging. When the user instructs imaging, the control routine shown in FIG. 8 is executed by the CPU 70A.

First, in step 100, in order to instruct the imaging unit 30 to pre-image the chemiluminescent sample at a predetermined first cooling temperature and first exposure time, imaging condition information representing these imaging conditions is transmitted to the imaging unit 30.

The first cooling temperature and the first exposure time are set to a standard temperature of the imaging element 88 at a time when the imaging unit 30 stands by, for example, and a predetermined standard chemiluminescent sample exposure time.

When the imaging unit 30 receives the imaging condition information, the control unit 80 controls the cooling element 90 such that the imaging element 88 reaches the first cooling temperature designated by the imaging condition information and controls the timing generator 86 such that the chemiluminescent sample is imaged in the first exposure time. Thus, the subject image transmitted through the lens unit 31 is imaged for the first exposure time on the light receiving surface of the imaging element 88.

Then, charges are sequentially outputted from each of the light receiving elements of the imaging element 88 to the charge-to-voltage conversion amp 92 and are converted into voltages, and then the voltages are outputted as analog signals to the signal processing unit 94. The aforementioned correlated double sampling processing and A/D conversion processing are performed in the signal processing unit 94, and the digital signals are primarily stored in the memory 96. The image data of the captured image that have been primarily stored are transmitted to the image processing device 100 via the communication I/F 84.

In step 102, the signal value of the detection target and the signal value of the background portion of the detection target are obtained on the basis of the image data of the captured image that have been transmitted from the imaging unit 30. Specifically, for example, a histogram of the pixel values of each pixel of the image data is obtained and, on the basis of this histogram, the signal value (pixel value) of the detection target and the signal value (pixel value) of the background portion of the detection target are obtained. Here, the signal value (signal strength) is larger the larger the pixel value is.

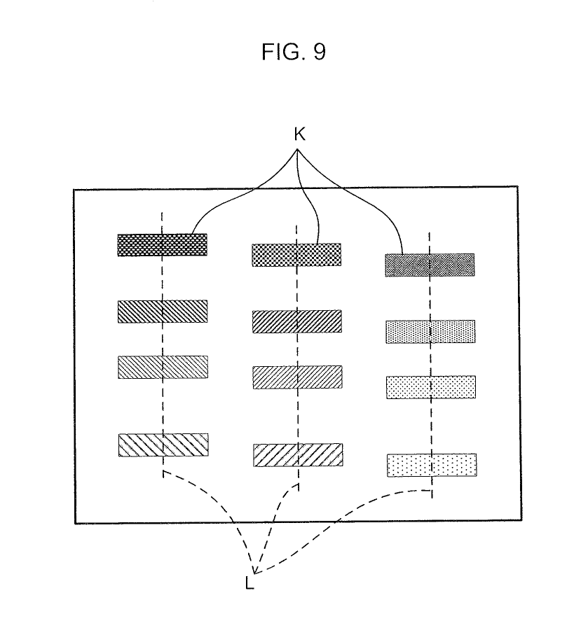

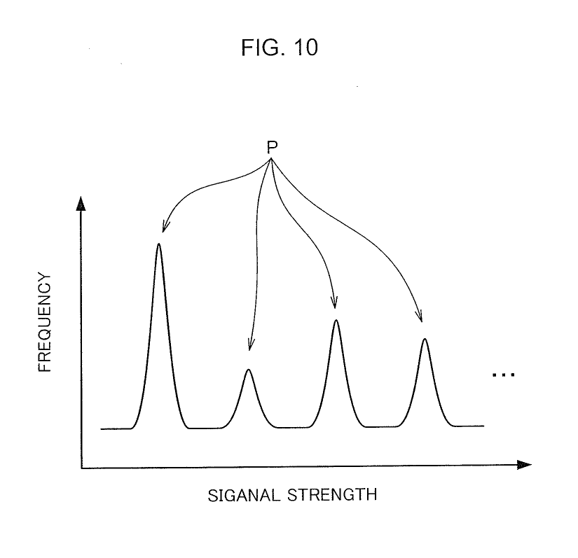

For example, in a case where the detection target is a chemiluminescent sample such as a protein and, as shown in FIG. 9, plural detection targets K have been imaged, when a histogram of these image data is obtained, as shown in FIG. 10, peaks P appear in positions corresponding to each of the detection targets and the background portion. The pixel values (signal strengths) of each of these peaks correspond to the signal values of each of the detection targets and the signal value of the background portion.

In the case of the captured images shown in FIG. 9, the signal strength of the background portion is thought to be the weakest and the frequency of the pixel value of the background portion is thought to be the highest, so the peak on the leftmost side in FIG. 10 is thought to correspond to the background portion and the peaks to the right of that are thought to correspond to the detection targets.

In step 104, the S/N ratio is obtained on the basis of the signal value of the detection target with the smallest luminescence, that is, the smallest signal value of the signal values of the detection targets obtained in step 102, and the signal value of the background portion. It suffices to do this by dividing, by the signal value of the background portion, the smallest signal value of the signal values of each of the detection targets obtained in step 102.

In step 106, it is judged whether or not the S/N ratio obtained in step 104 is equal to or greater than the predetermined reference S/N ratio. Here, the reference S/N ratio is a S/N ratio at which it can be judged to detect a detection target where it suffices for the S/N ratio to be equal to or greater than this value. In the present embodiment, the reference S/N ratio is 3 (the signal value (luminescence) of the detection target is three times the signal value (luminescence) of the background portion), but it is not limited to this.

If the S/N ratio obtained in step 104 is equal to or greater than the reference S/N ratio, the processing moves to step 108. If the S/N ratio obtained in step 104 is less than the reference S/N ratio, the processing moves to step 114.

In step 108, it is judged whether or not there exists a signal value reaching a predetermined saturated region among the signal values of each of the detection targets. Here, the saturated region is a region near an upper limit including an upper limit of a range in which signal values can be acquired; this region is a region in which the signal values do not become higher in proportion to luminescence even if the luminescence of the detection target increases beyond that.

In a case where there exists a signal value reaching the predetermined saturated region of the signal values of each of the detection targets, the processing moves to step 110. On the other hand, in a case where such a signal value does not exist, the control routine is completed. That is, the image obtained by the pre-imaging in step 100 is used as the image in the imaging.

In step 110, by referring to the table data shown in FIG. 7, it is judged whether or not there exists, among the combinations of cooling temperatures and exposure times corresponding to the signal value of the detection target with the smallest luminescence obtained in step 104, a combination of the first cooling temperature and a second exposure time that is shorter than the first exposure time and with which the S/N ratio becomes equal to or greater than the reference S/N ratio. In a case where such a second exposure time exists, the processing moves to step 112. In a case where such a condition does not exist, the control routine is completed.

In step 112, the imaging unit 30 is instructed to perform the imaging at the first cooling temperature and in the second exposure time. Thus, the imaging unit 30 performs the imaging at the first cooling temperature and in the second exposure time and transmits the image data of that captured image to the image processing device 100.

For example, in a case where the signal value of the detection target with the smallest luminescence obtained in step 104 is 10 [e−/sec·pix] in a case where the first cooling temperature is −20[° C.] and the first exposure time is 100 [sec], the S/N ratio becomes 25.21793 from the table data shown in FIG. 7. Additionally, even if the exposure time is changed to 10 [sec] without changing the cooling temperature, the S/N ratio becomes 4.127532, which is equal to or greater than the reference S/N ratio. Consequently, in this case, 10 [sec] is used as the second exposure time. Thus, the exposure time can be prevented from becoming needlessly long.

In step 114, it is judged whether or not the S/N ratio obtained in step 104 is within a range that is greater than a predetermined lower limit S/N ratio and less than the reference S/N ratio. Here, the lower limit S/N ratio is set to a value with which it can be judged that it is difficult to detect the detection target in a case where the S/N ratio is equal to or less than this value. In the present embodiment, as one example, the lower limit S/N ratio is 1, but it is not limited to this.

In a case where the S/N ratio obtained in step 104 is within the above-described range, the processing moves to step 116. In a case where the S/N ratio obtained in step 104 is not within the above-described range, that is, in a case where the S/N ratio obtained in step 104 is equal to or less than the lower limit S/N ratio, the processing moves to step 120.

In step 116, by referring to the table data shown in FIG. 7 and it is judged whether or not there exists a combination of a second cooling temperature and a third exposure time that is equal to or less than a predetermined limit exposure time and with which the S/N ratio becomes equal to or greater than the reference S/N ratio.

Here, the limit exposure time is set to an amount of time that can be allowed as an amount of time in which the user stands by until the user acquires the captured image if the exposure time is equal to or less than this value.

In a case where there exists a combination of a second cooling temperature and a third exposure time that is equal to or less than the predetermined limit exposure time and with which the S/N ratio becomes equal to or greater than the reference S/N ratio, the processing moves to step 118. In a case where such a combination does not exist, the processing moves to step 120.

In step 118, the imaging unit 30 is instructed to perform the imaging at the second cooling temperature and in the third exposure time. Thus, the imaging unit 30 performs the imaging at the second cooling temperature and in the third exposure time and transmits the image data of that captured image to the image processing device 100.

For example, in a case where the signal value of the detection target with the smallest luminescence obtained in step 104 is 3 [e−/sec·pix] in a case where the first cooling temperature is −10[° C.] and the first exposure time is 100 [sec], the S/N ratio becomes 1.475983 from the table data shown in FIG. 7. In a case where the limit exposure time have been set to 1000 [sec], if the cooling temperature is −20[° C.] and the exposure time is 100 [sec], the S/N ratio becomes 7.56538, which is equal to or greater than the reference S/N ratio. Consequently, in this case, −20[° C.] is used for the second cooling temperature and 100 [sec] is used for the third exposure time. Thus, the cooling temperature can be prevented from falling more than necessary and the exposure time can be prevented from becoming longer than necessary.

A case where the processing moves to step 120 is a case where the S/N ratio obtained in step 104 is equal to or less than the lower limit S/N ratio or where a second cooling temperature that is equal to or less than the limit exposure time and with which the S/N ratio becomes equal to or greater than the reference S/N ratio do not exist, and it is considered that raising the S/N ratio is difficult unless the cooling temperature is lowered a lot more. Consequently, in this case, the cooling temperature is set to a minimum cooling temperature. Then, in step 122, the user sets the exposure time.

In step 124, the imaging unit 30 is instructed to perform the imaging at the minimum cooling temperature and in the exposure time set by the user. Thus, the imaging unit 30 performs the imaging at the minimum cooling temperature and in the exposure time set by the user and transmits the image data of that captured image to the image processing device 100.

In the present embodiment, a case where the cooling temperature is set to the minimum cooling temperature in step 120 and the user sets the exposure time in step 122 has been described. However, the embodiment may also be configured such that, for example, the cooling temperature may be lowered by one step, the exposure time may be lengthened by one step, again the pre-imaging may be performed, and this processing may be repeated until the S/N ratio becomes equal to or greater than the reference S/N ratio.

In this manner, in the present embodiment, the cooling temperature and the exposure time with which the S/N ratio becomes equal to or greater than the reference S/N ratio are determined depending on the light amount of the detection target on the basis of the table data representing the correspondence relationships between the signal values based on light amounts of detection targets, cooling temperatures of the cooling element, exposure times when imaging a subject, and S/N ratios, and then the imaging is performed, so the cooling temperature can be prevented from becoming lower than necessary and the exposure time can be prevented from becoming longer than necessary.

In the present embodiment, a case where a histogram of the image data of the captured image transmitted from the imaging unit 30 is obtained and, on the basis of this histogram, the S/N ratio is automatically obtained on the basis of the smallest signal value of the signal values of each of the detection targets and the signal value of the background portion has been described, but the invention is not limited to this. As shown in FIG. 9, in a case where the placement of the detection targets is generally fixed, the invention may also be configured such that the signal strength distributions in lines L crossing the detection targets are obtained on the basis of the image data of the captured image, signal strength distributions in lines L crossing the detection targets and, on the basis of these signal strength distributions, the S/N ratio is automatically obtained on the basis of the smallest signal value of the signal values of each of the detection targets and the signal value of the background portion.

Rather than automatically detecting the detection target and the background portion and obtaining the S/N ratio, the invention may also be configured to have the display unit 202 display the image data of the captured image, allow the user to designate the detection target and the background portion, and obtain the S/N ratio on the basis of the signals value of the detection target and the signal value of the background portion that have been designated.

The invention may also be configured such that the table data shown in FIG. 7 is updated. For example, first a dark image is captured in a state where no light is incident on the lens unit 31, and the dark current noise and the readout noise are obtained per different cooling temperature. Then, samples with different luminescences are imaged in combinations of different cooling temperatures and exposure times, the above-described expressions (1) to (3) are used to calculate the S/N ratios in the combinations of different cooling temperatures and exposure times, and the S/N ratios are stored as the table data shown in FIG. 7. Thus, the precision of the table data can be maintained, so that even in a case where the dark current noise and the readout noise change over time, cooling temperatures and exposure times can be optimally determined depending on the luminescence of the subject.

In the present embodiment, a case where the CPU 70A of the image processing device 100 executes the processing shown in FIG. 8 has been described. However, the invention may also be configured such that the table data of FIG. 7 and the control program are stored in the imaging unit 30 and such that the processing shown in FIG. 8 is executed by the control unit 80 of the imaging unit 30.

In the present embodiment, a case where the invention is applied to a device that images chemiluminescent samples and fluorescent samples has been described, but the invention is not limited to this. The invention can also be applied to a device that captures microscopic images or a device that images of celestial bodies.

The configuration (see FIG. 1 to FIG. 4) of the imaging system 1 described in the present embodiment is one example, and it goes without saying that unnecessary portions may be omitted and new portions may be added in a scope that does not depart from the gist of the invention.

The flow of processing (see FIG. 8) of the control program described in the present embodiment is also one example, and it goes without saying that unnecessary steps may be omitted, new steps may be added, and the processing order may be changed in a scope that does not depart from the gist of the invention.

According to a first aspect of the invention, there is provided an imaging device which includes: an imaging element that images a subject including predetermined detection targets; a cooling unit that cools the imaging element; a storage unit that stores table data representing correspondence relationships between signal values based on light quantities of the detection targets, cooling temperatures of the cooling unit, exposure times when imaging the subject, and S/N ratios that are ratios between the signal values based on the light quantities of the detection targets and a signal value of a light quantity of a background portion of the detection targets; a S/N ratio calculating unit that calculates a S/N ratio when the subject has been pre-imaged by the imaging element at a predetermined reference cooling temperature and in a predetermined reference exposure time; a determination unit which, on the basis of the result of a comparison between the S/N ratio calculated by the S/N ratio calculating unit and a predetermined reference S/N ratio, determines, from the table data and as a cooling temperature and an exposure time for the imaging, a combination of a cooling temperature and an exposure time with which the S/N ratio becomes equal to or greater the reference S/N ratio from among combinations of the cooling temperatures and the exposure times based on the light quantities of the detection targets when the pre-imaging was performed; and a control unit that controls the imaging element and the cooling unit such that the subject is imaged at the cooling temperature and in the exposure time that are determined by the determination unit.

According to the invention pertaining to the first aspect, the table data representing the correspondence relationships between the signal values based on the light amounts of the detection targets, the cooling temperatures of the cooling unit, the exposure times when imaging the subject, and the S/N ratios that are ratios between the signal values based on the light quantities of the detection targets and the signal value based on the light quantity of the background portion of the detection targets are stored, and, on the basis of the result of the comparison between the S/N ratio when the subject has been pre-imaged at the predetermined reference cooling temperature and in the predetermined exposure time and the reference S/N ratio, the cooling temperature and the exposure time with which the S/N ratio becomes equal to or greater than the reference S/N ratio is determined from as the table data as the cooling temperature and the exposure time for the imaging from among the combinations of the cooling temperatures and the exposure times corresponding to the signal values based on the light quantities of the detection targets when the pre-imaging has been performed, and then the imaging is performed. Thus, an optimum cooling temperature and exposure time can be determined depending on the luminescence of the subject, and the cooling temperature can be prevented from becoming lower than necessary and the exposure time can be prevented from becoming longer than necessary.

According to a second aspect of the invention, in the first aspect, in a case where the S/N ratio calculated by the S/N ratio calculation unit is equal to or greater than the reference S/N ratio, in a case where a combination with which the S/N ratio becomes equal to or greater than the reference S/N ratio and which includes a shorter exposure time than the reference exposure time exists among the combinations of the cooling temperatures and the exposure times corresponding to the signal values based on the light quantities of the detection targets when the pre-imaging was performed, the determination unit may determine the cooling temperature and the exposure time of that combination as the cooling temperature and the exposure time for the imaging.

Thus, the exposure time can be prevented from becoming longer than necessary.

According to a third aspect of the invention, in the first aspect, in a case where the S/N ratio calculated by the S/N ratio calculation unit is less than the reference S/N ratio, in a case where a combination having a cooling temperature with which the S/N ratio becomes equal to or greater than the reference S/N ratio at a predetermined limit exposure time longer than the reference exposure time exists among the combinations of the cooling temperatures and the exposure times corresponding to the signal values based on the light quantities of the detection targets when the pre-imaging was performed, the determination unit may determine the highest cooling temperature of those cooling temperatures and the limit exposure time as the cooling temperature and the exposure time for the imaging.

Thus, the cooling temperature can be prevented from becoming lower than necessary.

According to a fourth aspect of the invention, in the first aspect, the S/N ratio calculation unit may calculate a histogram of pixel values of each pixel of the captured image at the time when the pre-imaging was performed and may calculate, on the basis of the calculated histogram, the S/N ratio at the time when the pre-imaging was performed.

Thus, it is not necessary for the user to designate the detection targets and the background portion, and the detection targets can be automatically detected from the captured image to obtain the S/N ratio.

According to a fifth aspect of the invention, in the first aspect, the signal value based on the light quantity of the background portion of the detection targets of the table data may be calculated on the basis of measurement results of dark current noise and readout noise generated when reading out image signals from the imaging element.

Thus, the cooling temperature and the exposure time can be determined more optimally.

According to a sixth aspect of the invention, in the first aspect, the detection targets may be chemiluminescent substances.

In this case, the effects of the invention become particularly remarkable because the exposure time when performing imaging becomes long and cooling of the imaging element becomes necessary.

According to a seventh aspect of the invention, there is provided a computer-readable non-transitory medium which stores an imaging program causing a computer to execute an imaging processing, the imaging processing including: calculating a S/N ratio when a subject has been pre-imaged by an imaging element at a predetermined reference cooling temperature and in a predetermined reference exposure time using an imaging device equipped with the imaging element that images the subject including predetermined detection targets, a cooling unit that cools the imaging element, and a storage unit that stores table data representing correspondence relationships between signal values based on light quantities of the detection targets, cooling temperatures of the cooling unit, exposure times when imaging the subject, and S/N ratios that are ratios between the signal values based on the light quantities of the detection targets and a signal value of a light quantity of a background portion of the detection targets; determining, from the table data and as a cooling temperature and an exposure time for the imaging, a combination of a cooling temperature and an exposure time with which the S/N ratio becomes equal to or greater the reference S/N ratio from among combinations of the cooling temperatures and the exposure times based on the light quantities of the detection targets when the pre-imaging was performed, on the basis of the result of a comparison between the calculated S/N ratio and a predetermined reference S/N ratio; and controlling the imaging element and the cooling unit such that the subject is imaged at the cooling temperature and in the exposure time that are determined.

According to the invention pertaining to the seventh aspect, an optimum cooling temperature and exposure time can be determined depending on the luminescence of the subject, and the cooling temperature can be prevented from becoming lower than necessary and the exposure time can be prevented from becoming longer than necessary.

According to the present invention, an optimum cooling temperature and exposure time can be determined depending on the luminescence of the subject, and needless consumption of electrical power at the time of imaging can be suppressed.

Embodiments of the present invention are described above, but the present invention is not limited to the embodiments as will be clear to those skilled in the art.

What is claimed is:

1. An imaging device comprising:
an imaging element that images a subject including predetermined detection targets;
a cooling unit that cools the imaging element;
a storage unit that stores table data representing correspondence relationships between signal values based on light quantities of the detection targets, cooling temperatures of the cooling unit, exposure times when imaging the subject, and S/N ratios that are ratios between the signal values based on the light quantities of the detection targets and a signal value of a light quantity of a background portion of the detection targets;
a S/N ratio calculating unit that calculates a S/N ratio when the subject has been pre-imaged by the imaging element at a predetermined reference cooling temperature and in a predetermined reference exposure time;
a determination unit which, on the basis of the result of a comparison between the S/N ratio calculated by the S/N ratio calculating unit and a predetermined reference S/N ratio, determines, from the table data and as a cooling temperature and an exposure time for the imaging, a combination of a cooling temperature and an exposure time with which the S/N ratio becomes equal to or greater the reference S/N ratio from among combinations of the cooling temperatures and the exposure times based on the light quantities of the detection targets when the pre-imaging was performed; and
a control unit that controls the imaging element and the cooling unit such that the subject is imaged at the cooling temperature and in the exposure time that are determined by the determination unit.

2. The imaging device according to claim 1, wherein in a case where the S/N ratio calculated by the S/N ratio calculation unit is equal to or greater than the reference S/N ratio, in a case where a combination with which the S/N ratio becomes equal to or greater than the reference S/N ratio and which includes a shorter exposure time than the reference exposure time exists among the combinations of the cooling temperatures and the exposure times corresponding to the signal values based on the light quantities of the detection targets when the pre-imaging was performed, the determination unit determines the cooling temperature and the exposure time of that combination as the cooling temperature and the exposure time for the imaging.

3. The imaging device according to claim 1, wherein in a case where the S/N ratio calculated by the S/N ratio calculation unit is less than the reference S/N ratio, in a case where a combination having a cooling temperature with which the S/N ratio becomes equal to or greater than the reference S/N ratio at a predetermined limit exposure time longer than the reference exposure time exists among the combinations of the cooling temperatures and the exposure times corresponding to the signal values based on the light quantities of the detection targets when the pre-imaging was performed, the determination unit determines the highest cooling temperature of those cooling temperatures and the limit exposure time as the cooling temperature and the exposure time for the imaging.

4. The imaging device according to claim 1, wherein the S/N ratio calculation unit calculates a histogram of pixel values of each pixel of the captured image at the time when the pre-imaging was performed and calculates, on the basis of the calculated histogram, the S/N ratio at the time when the pre-imaging was performed.

5. The imaging device according to claim 1, wherein the signal value based on the light quantity of the background portion of the detection targets of the table data is calculated on the basis of measurement results of dark current noise and readout noise generated when reading out image signals from the imaging element.

6. The imaging device according to claim 1, wherein the detection targets are chemiluminescent substances.

7. A computer-readable non-transitory medium storing an imaging program causing a computer to execute an imaging processing, the imaging processing comprising:
calculating a S/N ratio when a subject has been pre-imaged by an imaging element at a predetermined reference cooling temperature and in a predetermined reference exposure time using an imaging device equipped with the imaging element that images the subject including predetermined detection targets, a cooling unit that cools the imaging element, and a storage unit that stores table data representing correspondence relationships between signal values based on light quantities of the detection targets, cooling temperatures of the cooling unit, exposure times when imaging the subject, and S/N ratios that are ratios between the signal values based on the light quantities of the detection targets and a signal value of a light quantity of a background portion of the detection targets;
determining, from the table data and as a cooling temperature and an exposure time for the imaging, a combination of a cooling temperature and an exposure time with which the S/N ratio becomes equal to or greater the reference S/N ratio from among combinations of the cooling temperatures and the exposure times based on the light quantities of the detection targets when the pre-imaging was performed, on the basis of the result of a comparison between the calculated S/N ratio and a predetermined reference S/N ratio; and
controlling the imaging element and the cooling unit such that the subject is imaged at the cooling temperature and in the exposure time that are determined.
